(19) United States
(12) Patent Application Publication
(10) Pub. No.: US 2025/0028385 A1
(43) Pub. Date: Jan. 23, 2025

(54) METHOD AND APPARATUS FOR POSE ESTIMATION, AND ELECTRONIC DEVICE

(71) Applicant: Beijing Zitiao Network Technology Co., Ltd., Haidian District, Beijing (CN)

(72) Inventors: Xiaozheng Zheng, Beijing (CN); Zhuo Su, Beijing (CN); Chao Wen, Beijing (CN); Zhou Xue, Beijing (CN)

(21) Appl. No.: 18/778,780

(22) Filed: Jul. 19, 2024

(30) Foreign Application Priority Data
Jul. 20, 2023 (CN) 202310896769.5

(51) Int. Cl. G06F 3/01; G06F 3/0346

(52) U.S. Cl. CPC G06F 3/012; G06F 3/0346

(57) ABSTRACT

The embodiments of the application discloses a method and apparatus for pose estimation, and an electronic device. A specific implementation of the method includes: obtaining an observation information sequence corresponding to a human target part, wherein the human target part comprises at least one of the following: a head and a hand; determining an initial human joint point feature based on the observation information sequence; and performing feature interaction based on the initial human joint point feature, and estimating a human pose using an interaction feature, so as to obtain human pose information. This implementation makes the estimated human pose more accurate and realistic.

### CROSS-REFERENCE

The present application claims priority to Chinese Patent Application No. 202310896769.5, filed on Jul. 20, 2023 and entitled “METHOD AND APPARATUS FOR POSE ESTIMATION, AND ELECTRONIC DEVICE”, the entirety of which is incorporated herein by reference.

### FIELD

Embodiments of the present disclosure relate to the field of computer technology, and in particular, to a method and an apparatus for pose estimation, and an electronic device.

### BACKGROUND

Human pose estimation is an important task in computer vision, and it is also an essential step for a computer to understand human actions and behaviors. In an XR (Extended Reality) scenario, estimation of a human pose may further serve a downstream task, such as a game etc., to render the human pose of a user, which may improve the immersion sense of the user.

### SUMMARY

The content of this section is provided to introduce the concepts in a simplified form, which are described in detail in the Detailed Description section that follows. The content of this section is not intended to identify key features or essential features of the claimed subject matter, nor is it intended to be used to limit the scope of the claimed subject matter.

In a first aspect, an embodiment of the present disclosure provides a method for pose estimation, including: obtaining an observation information sequence corresponding to a human target part, wherein the human target part comprises at least one of the following: a head and a hand; determining an initial human joint point feature based on the observation information sequence; and performing feature interaction based on the initial human joint point feature, and estimating a human pose using an interaction feature, so as to obtain human pose information.

In a second aspect, an embodiment of the present disclosure provides an apparatus for pose estimation. The apparatus includes: an obtaining unit configured to obtain an observation information sequence corresponding to a human target part, wherein the human target part comprises at least one of the following: a head and a hand; a determining unit configured to determine an initial human joint point feature based on the observation information sequence; and an interacting unit configured to perform feature interaction based on the initial human joint point feature, and estimate a human pose using an interaction feature, so as to obtain human pose information.

In a third aspect, an embodiment of the present disclosure provides an electronic device, including: one or more processors; and a storage device having one or more programs stored thereon, wherein when being executed by the one or more processors, the one or more processors implement the method for pose estimation according to the first aspect.

According to a fourth aspect, an embodiment of the present disclosure provides a computer readable medium on which a computer program is stored, wherein when being executed by a processor, the computer program implements steps of the method for pose estimation according to the first aspect.

According to the method and apparatus for pose estimation, and the electronic device provided by the embodiments of the present disclosure, an observation information sequence corresponding to a head and/or a hand is obtained; then, an initial human joint point feature is determined based on the observation information sequence; and then feature interaction is performed based on the initial human joint point feature, and a human pose is estimated using the interaction feature, so as to obtain human pose information. In this way, interaction is performed on the feature of the human joint point, and a human pose is estimated by using the interaction feature, so that the estimated human pose is more accurate and realistic.

### BRIEF DESCRIPTION OF THE DRAWINGS

The above and other features, advantages, and aspects of various embodiments of the present disclosure will become more apparent with reference to the following detailed description taken in conjunction with the accompanying drawings. The same or like reference numerals represent the same or like elements throughout the drawings, it being understood that the drawings are illustrative and that the elements and primaries are not necessarily drawn to scale.

FIG. 1 is a flowchart of one embodiment of the method for pose estimation according to the present disclosure;

FIG. 2 is a flowchart of another embodiment of the method for pose estimation according to the present disclosure;

FIG. 3 is a flowchart of yet another embodiment of the method for pose estimation according to the present disclosure;

FIG. 4 is a flowchart of still another embodiment of the method for pose estimation according to the present disclosure;

FIG. 5 is a schematic diagram of an application scenario of the method for pose estimation according to the present disclosure;

FIG. 6 is a schematic structural diagram of one embodiment of the apparatus for pose estimation according to the present disclosure;

FIG. 7 is an exemplary system architecture diagram in which various embodiments of the present disclosure may be applied;

FIG. 8 is a schematic structural diagram of a computer system suitable for implementing an electronic device according to an embodiment of the present disclosure.

### DETAILED DESCRIPTION

The following will describe the embodiments of the present disclosure in more detail with reference to the accompanying drawings. Although some embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the drawings and embodiments of the present disclosure are provided for illustrative purposes only and are not intended to limit the scope of protection of the present disclosure.

It should be understood that the various steps described in the method implementation of this disclosure can be executed in different orders and/or in parallel. In addition, the method implementation can include additional steps and/or the steps as shown may be omitted. The scope of this disclosure is not limited in this regard.

The term “including” and its variations as used herein are non-exclusive inclusion, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in this disclosure are only used to distinguish different devices, modules, or units, but are not used to limit the order or interdependence of the functions performed by these devices, modules, or units.

It should be noted that the modifications of “one” and “a plurality of” mentioned in this disclosure are illustrative but not limiting. Those skilled in the art should understand that unless otherwise indicated in the context, they should be understood as “one or more”.

The names of messages or information interacted between a plurality of devices in the embodiments of the present disclosure are only described for illustrative purposes, and are not intended to limit the scope of these messages or information.

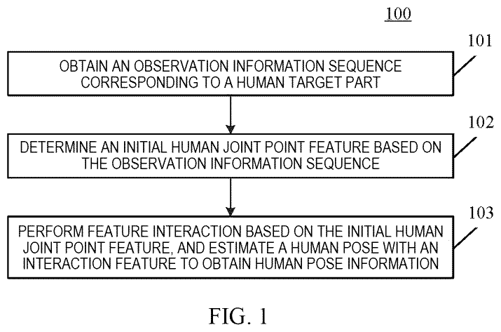

Referring to FIG. 1, FIG. 1 illustrates a flowchart 100 of one embodiment of a method for pose estimation according to the present disclosure. The method for pose estimation includes the following steps:

Step 101: an observation information sequence corresponding to a human target part is obtained.

In this embodiment, an execution subject of the method for pose estimation may obtain an observation information sequence corresponding to a human target part. The observation information in the described observation information sequence is generally sorted in a sequence from front to back according to the collection time point at which the observation information is collected. The above human target part may include at least one of the following: a head and a hand.

Here, the execution subject may obtain a sequence of observation information of 6 DoF (six degrees of freedom) about the human hand joint point and the head joint point. Specifically, the observation information of the head joint point may be collected by using a head display of a XR device, and the observation information of the hand joint point may be collected by using a handle of the XR device. 6DoF includes three-dimensional coordinates of a joint point in the world coordinate system and three rotation angles, and the three rotation angles typically include roll, pitch and yaw. The XR device of 6DoF can simulate almost all head dynamics and hand dynamics.

The above execution subject may splice the three-dimensional coordinate and the rotation angle of a joint point observed each time into a one-dimensional vector, and add the one-dimensional vector to the observation information sequence as the observation information.

At step 102, an initial human joint point feature is determined based on the observation information sequence.

In this embodiment, the above execution subject may determine the initial human joint point feature based on the observation information sequence obtained in Step 101. Here, the human joint point may be a preset joint point, for example, a preset number (for example, 22) of joint points distributed over important parts of a human (for example, a head, a shoulder, an arm, a hand, a pelvis, a leg, a foot, and the like).

Here, the execution subject may store a correspondence table indicating a correspondence between the observed information sequences and the human joint point features, and the execution subject may search the correspondence table for a human joint point feature corresponding to the observation information sequence obtained in Step 101 as the initial human joint point feature.

Step 103: feature interaction is performed based on the initial human joint point feature, and a human pose is estimated using an interaction feature, so as to obtain human pose information.

In this embodiment, the above execution subject may perform feature interaction based on the initial human joint point feature, and estimate a human pose by using the interaction feature, so as to obtain the human pose information. Herein, performing feature interaction on the joint point may also be understood here as determining a correlation between the joint points. The correlation between human joint points is determined by means of the initial human joint point feature. If the correlation between the joint points is relatively small, current positions of the joint points can be corrected, thereby improving the correlation between the joint points, to estimate the human pose more accurately.

According to the method provided in the above embodiment of the present disclosure, an observation information sequence corresponding to a head and/or a hand is obtained; then, an initial human joint point feature is determined based on the observation information sequence; and then feature interaction is performed based on the initial human joint point feature, and a human pose is estimated using the interaction feature, so as to obtain human pose information. In this way, interaction is performed on the feature of the human joint point, and a human pose is estimated by using the interaction feature, so that the estimated human pose is more accurate and realistic.

In some alternative implementations, the observation information may include a movement velocity and an angular velocity of a joint point. After a sequence of the three-dimensional coordinates and rotation angles of a human hand joint point and/or a head joint point is collected, the movement velocities of the joint point during multiple collection processes can be determined by using the three-dimensional coordinates of the joint point collected multiple times, and the acceleration of the joint point is determined using the movement velocities, and then the three-dimensional coordinate, the rotation angle, the movement velocity and the acceleration of the joint point observed each time can be spliced into a one-dimensional vector, and then added to the observation information sequence as observation information.

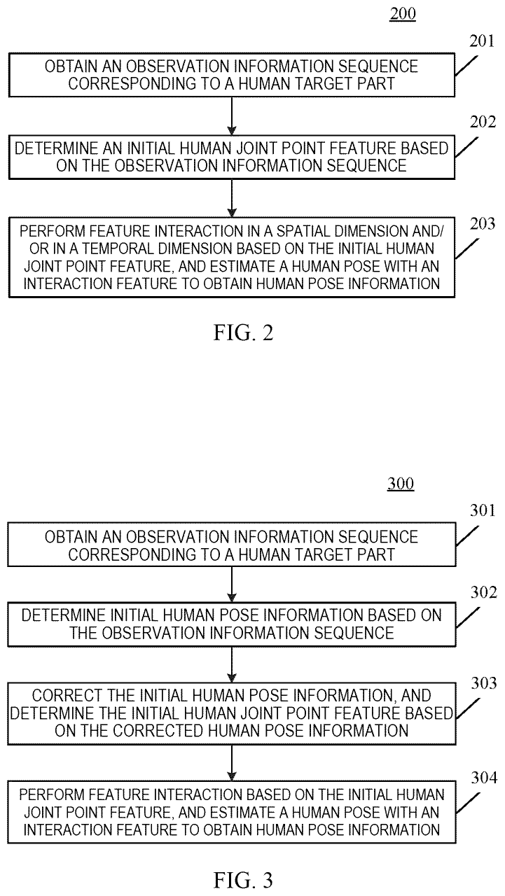

Please refer to FIG. 2, FIG. 2 illustrates a flow 200 of another embodiment of a method for pose estimation. The flow 200 of the method for pose estimation includes the following steps:

Step 201, an observation information sequence corresponding to a human target part is obtained.

Step 202, an initial human joint point feature is determined based on the observation information sequence.

In this embodiment, Steps 201-202 may be performed in a manner similar to Steps 101-102, which are not described herein again.

Step 203: the feature interaction is performed in a spatial dimension and/or in a temporal dimension based on the initial human joint point feature, and the human pose is estimated using the interaction feature, so as to obtain the human pose information.

In this embodiment, an execution subject of the method for pose estimation may perform the feature interaction in the spatial dimension and/or the temporal dimension based on the initial human joint point feature determined in Step 202, and estimate the human pose by using the interaction feature, so as to obtain the human pose information.

As an example, the above-described execution subject may input the above initial human joint point feature into the Transformer-based network structure to obtain the interaction feature in the spatial dimension and/or in the temporal dimension. The Transformer is a neural network model structure that completely utilizes attention mechanism for computation, which has characteristics of high parallelism, a large receptive field, and the ability to process sequential data. The above Transformer-based network structure can be used to perform feature interaction on the input initial human joint point features.

As can be seen in FIG. 2, compared to the embodiment corresponding to FIG. 1, the flow 200 of the method for pose estimation in the present embodiment includes the step of performing interaction on the joint point feature in the spatial dimension and/or in the temporal dimension. As a result, the solution described in this embodiment may improve the accuracy of the interaction features.

In some optional implementations, the above-described execution subject may perform feature interaction in the spatial dimension and/or in the temporal dimension based on the above initial human joint point feature in the following manner: for each collection point in a collection time period, the above execution subject may determine an attention score between an initial human joint point feature corresponding to the collection point and a target input feature, and may perform interaction on the initial human joint point feature corresponding to the collection point and the target input feature by using the attention score, to obtain an interaction feature in the spatial dimension.

Here, the above target input feature may be obtained by mapping a high-dimensional input feature to a same dimension of the initial whole-body joint point feature corresponding to the collection point. The above high-dimensional input feature may be obtained by inputting the observation information sequence to the joint point prediction sub-model, for example, may be obtained by inputting the observation information sequence to a linear layer of the joint point prediction sub-model. The above collection time period may be a time period for collecting the observation information sequence.

In this way, the correlation of the joint points in the spatial dimension can be captured, and the positions of respective joint points are corrected through the correlation, so that the pose estimation is more accurate.

In some optional implementations, the execution subject may perform the feature interaction in the spatial dimension and/or in the temporal dimension based on the initial human joint point feature in the following way: for each joint point of the described human joint points, the execution subject may determine an attention score between the plurality of initial joint point features of the joint point within a collection time period; then, the interaction is performed on the plurality of initial joint point features corresponding to the joint point by using the above attention scores, so as to obtain an interaction feature in a temporal dimension. The foregoing collection time period may be a time period for collecting the observation information sequence.

In this way, the movement pattern of each joint point in the temporal dimension can be captured, so that the joint point is reasonable in a movement process, and accuracy of pose estimation is further improved.

In some optional implementations, the execution subject may perform feature interaction in the spatial dimension and/or in the temporal dimension based on the initial human joint point feature in the following manner: the execution subject may input the initial human joint point feature and a target input feature into a pre-trained feature interaction network to obtain the interaction feature. The feature interaction network may be configured to characterize the correspondence between the joint point feature and the interaction feature and the correspondence between the input feature and the interaction feature. The interaction feature may include an interaction feature of a human joint point in the spatial dimension and an interaction feature of a human joint point in the temporal dimension. The target input feature may be determined based on the observation information sequence, such as, it may be obtained by inputting the observation information sequence to a linear layer of a pre-trained joint point prediction sub-model.

In some optional implementations, the above feature interaction network may include at least two first coding layers and at least two second coding layers, where the first coding layer may be configured to perform feature interaction in the spatial dimension, for example, it may be a Transform-Encoder (encoding) layer in the spatial dimension, and the second coding layer may be configured to perform feature interaction in the temporal dimension, for example, may be a Transform-Encoder layer in the temporal dimension.

The execution subject may input the initial human joint point feature and the target input feature into the pre-trained feature interaction network to obtain an interaction feature in the following manner: the execution subject may input the initial human joint point feature and the target input feature into alternately arranged first coding layer and second coding layer to obtain the interaction feature. As an example, if the feature interaction network includes three first coding layers and three second coding layers, the input initial human joint point feature and target input feature may pass through the first one of the first coding layers, the first one of the second coding layers, the second one of the first coding layers, the second one of the second coding layers, the third one of the first coding layers and the third one of the second coding layers.

The alternately arranged network structure may iteratively correct the position relationship in the spatial dimension and the joint point movement relationship in the temporal dimension, so as to achieve a better effect.

It should be noted that the feature interaction network may further include a position coding layer. In the spatial dimension, a learnable parameter of a dimension 2×22×512 (where, 2 represents two dimensions, i.e. a rotation angle and a coordinate, and 22 represents the number of joint points) may be added to the initial human joint point feature collected each time to represent relative positions among all joint points. In the temporal dimension, a learnable parameter of a dimension t×512 (where t represents the number of collected points) is added to the feature of each joint point to represent the relative position of each joint point in the time sequence.

With further reference to FIG. 3, a flow 300 of another embodiment of a method for pose estimation is illustrated. The flow 300 of the method for pose estimation includes steps of:

Step 301: an observation information sequence corresponding to a human target part is obtained.

In this embodiment, Step 301 may be performed in a manner similar to Step 101, which is not described herein again.

Step 302, initial human pose information is determined based on the observation information sequence.

In this embodiment, the execution subject of the method for pose estimation may determine the initial human pose information based on the above observation information sequence. The execution subject may input the observation information sequence into a first linear layer and a pose regression layer to obtain the initial human pose information.

Here, the above first linear layer may be a fully-connected layer, and is generally configured to map an input observation information sequence to a high-dimensional input feature (for example, 1024 dimensions). The pose regression layer may be formed by a multilayer perceptron (MLP), and is generally configured to map the input feature output by the first linear layer as the initial human pose information.

In this embodiment, a multilayer perception is a feedforward artificial neural network model, which maps a plurality of input data sets onto a single output data set. The multilayer perception herein may have two-layer fully-connected layers with a hidden layer dimension of 1024 and one layer of ReLU activation function layer. The output of the multilayer perceptron may be a rotation representation of the 22 joint points in 6 dimensions, with a total output dimension of 6×22=132.

Step 303: the initial human pose information is corrected, and the initial human joint point feature is determined based on the corrected human pose information.

In this embodiment, the execution subject may correct the initial human pose information, and may determine the initial human joint point feature based on the corrected human pose information.

Here, the execution subject may determine whether a human pose characterized by the initial human pose information is reasonable, and if the human pose characterized by the initial human pose information is not reasonable, the initial human pose information needs to be corrected so that the human pose represented by the corrected human pose information is reasonable.

Then, the corrected human pose information may be input into the second linear layer to obtain the initial human joint point feature. The second linear layer may be a two-layer fully-connected layer, which is configured to map a rotation angle and a coordinate position in the corrected initial human pose information as the high-dimensional initial human joint point feature (for example, 512 dimensions).

Step 304: feature interaction is performed based on the initial human joint point feature, and a human pose is estimated using an interaction feature, so as to obtain human pose information.

In this embodiment, Step 304 may be performed in a manner similar to Step 103, which is not described herein again.

It can be seen from FIG. 3 that, compared with the embodiment corresponding to FIG. 1, the flow 300 of the method for pose estimation in this embodiment includes steps of correcting the initial human pose information and determining the initial human joint point feature based on the corrected human pose information. Thus, the solution described in this embodiment can make the initial human joint point feature more accurate and reasonable, and make the human pose estimation more accurate and realistic.

In some optional implementations, the initial human pose information may include a relative rotation angle of a human joint point under a human parameterized grid model and/or a joint point coordinate of the human joint point under the human parameterized grid model. The observation information sequence may include a rotation angle and/or a joint point coordinate of a joint point on the human target part.

The execution subject may correct the initial human pose information in at least one of the following manners:

If the initial human pose information includes the relative rotation angle of the human joint point under the human parameterized grid model and the observation information sequence includes the rotation angle of the joint point on the human target part, the execution body may replace a rotation angle of the joint point on the human target part in the initial human pose information with the rotation angle of the joint point on the human target part in the observation information sequence. It should be noted that, since the rotation angle of the joint point on the human target part in the observation information sequence is a global rotation angle (namely, an absolute rotation angle), it is necessary to convert the relative rotation angle of the human joint point under the human parameterized grid model into the global rotation angle.

If the initial human pose information includes a joint point coordinate of the human joint point under the human parameterized grid model and the observation information sequence includes a joint point coordinate on the human target part, the execution subject may replace the joint point coordinate of the joint point on the human target part in the initial human pose information with the joint point coordinate of the joint point on the human target part in the observation information sequence. It should be noted that, since the joint point coordinate of the joint point on the human target part in the observation information sequence is a coordinate in the world coordinate system, it is necessary to first convert the joint point coordinate of the human joint point in the human parameterized grid model into a joint point coordinate in the world coordinate system.

In this way, the input rotation angle and joint point coordinate of the human joint point may be used to correct the rotation angle and joint point coordinate in the estimated human pose information, so that the initial human joint point feature is more accurate.

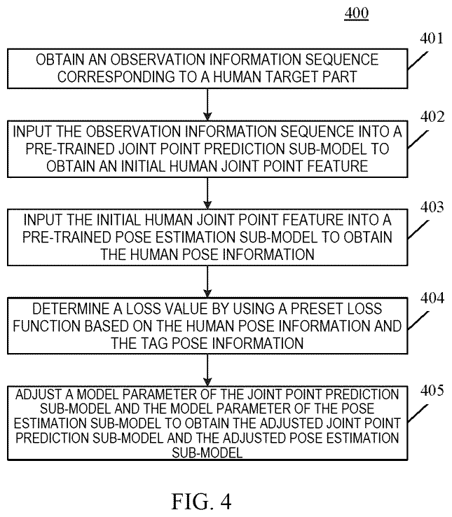

With further reference to FIG. 4, FIG. 4 illustrates a flow 400 of still another embodiment of a method for pose estimation. The method for pose estimation includes the following steps:

Step 401: an observation information sequence corresponding to a human target part is obtained.

In this embodiment, Step 401 may be performed in a manner similar to Step 101, which is not described herein again.

Step 402: the observation information sequence is input into a pre-trained joint point prediction sub-model to obtain an initial human joint point feature.

In this embodiment, the execution subject of the method for pose estimation may input the observation information sequence into the pre-trained joint point prediction sub-model to obtain the initial human joint point feature. The joint point prediction sub-model described above can be used to characterize the correspondence between the observation information sequence and the initial human joint point feature.

Here, the joint point prediction sub-model described above may include a first linear layer, a pose regression layer, and a second linear layer. Specifically, the first linear layer may be a fully-connected layer, and is generally configured to map the input observation information sequence to a high dimensional input feature (for example, 1024 dimensions). The pose regression layer may be formed by a multilayer perceptron, and is generally configured to map the input feature output by the first linear layer as the initial human pose information. The second linear layer may be a two-layer fully-connected layer, which is configured to map the rotation angle and a coordinate position in the initial human pose information to a high dimensional initial human joint point feature (for example, 512 dimensions).

In this embodiment, a multilayer perception is a feedforward artificial neural network model, which maps a plurality of input data sets onto a single output data set. The multilayer perception herein may have a two-layer fully-connected layer with a hidden layer dimension of 1024 and one layer of ReLU activation function layer. The output of the multilayer perceptron may be a rotation representation of the 22 joint points in 6 dimensions, with a total output dimension of 6×22=132.

Here, the above initial human pose information may include a relative rotation angle parameter (generally in a dimension of 6×22) under a skinned Multi-Person Linear Model (SMPL) and a joint point coordinate (generally in a dimension of 3×22) under the skinned Multi-Person Linear Model. The above relative rotation angle parameter may refer to a rotation angle parameter of one joint point with respect to another adjacent joint point. For example, the relative rotation angle of the ankle joint point may be a rotation angle with respect to the knee joint point in the skinned Multi-Person Linear Model.

The joint point coordinates under the skinned Multi-Person Linear Model may be obtained by decoding the relative rotation angle parameter under the skinned Multi-Person Linear Model. The skinned Multi-Person Linear Model is a parametrized network model designed for a human, including a parameter for controlling a shape and a parameter for controlling a pose.

Step 403: the initial human joint point feature is input into a pre-trained pose estimation sub-model to obtain the human pose information.

In this embodiment, the execution subject may input the initial human joint point feature obtained in Step 402 into the pre-trained pose estimation sub-model to obtain the human pose information. The pose estimation sub-model may be configured to represent a correspondence between the human joint point feature and the human pose information. The above pose estimation sub-model is generally used to capture, from the input initial human joint point features, the correlation between the human joint points in the spatial dimension and/or the temporal dimension, thereby regressing an accurate and realistic human pose.

Here, the human pose information may include a relative rotation angle parameter of a human joint point under a skinned Multi-Person Linear Model, and may also include a joint point coordinate of the human joint point under the skinned Multi-Person Linear Model; and the human pose information may also include a joint point coordinate of the human joint point in a world coordinate system. The joint point coordinate of the human joint point under the skinned Multi-Person Linear Model may be obtained by decoding the relative rotation angle parameter of the human joint point under the skinned Multi-Person Linear Model, the joint point coordinate of the human joint point in the world coordinate system may be obtained by aligning the joint point coordinate of the human joint point under the skinned Multi-Person Linear Model with the input head joint point coordinate and/or the hand joint point coordinate.

Here, the above pose estimation sub-model may include a Transformer-based network structure and a whole-body pose regression layer.

The transformer is a neural network model structure that completely utilizes the attention mechanism for computation, which has characteristics of high parallelism, a large receptive field, and the ability to process sequential data. The above Transformer-based network structure can be used to perform feature interaction on the input initial human joint point features.

The whole-body pose regression layer may be formed by a multilayer perceptron (MLP), which takes feature captured based on spatial-temporal relationship and output by the Transformer-based network structure as an input, and outputs the relative rotation angle parameter (generally in a dimension of 6×22) under the skinned Multi-Person Linear Model corresponding to each collection point. The multilayer perceptron in the whole-body pose regression layer may be formed by a two-layer fully-connected layer with a hidden layer dimension of 1024, one ReLU activation function layer and one Group Normalization layer. Group normalization is a faster and more stable method for training artificial neural networks by re-centering and re-scaling the inputs of layers.

Step 404: a loss value is determined by using a preset loss function based on the human pose information and the tag pose information.

In this embodiment, the above execution subject may determine the loss value by using a preset loss function (for example, an L1 norm) based on the human pose information and the tag pose information that are determined in Step 403. The execution subject may compare the human pose information and the tag pose information, and determine a difference value there between as the loss value.

Step 405, by using the loss value, a model parameter of the joint point prediction sub-model and a model parameter of the pose estimation sub-model are adjusted to obtain the adjusted joint point prediction sub-model and the adjusted pose estimation sub-model.

In this embodiment, the execution subject may adjust, by using the loss value, the model parameter of the joint point prediction sub-model and the model parameter of the pose estimation sub-model to obtain the adjusted joint point prediction sub-model and the adjusted pose estimation sub-model.

Here, training may be ended when a preset training ending condition is satisfied. For example, the preset training ending condition may include, but is not limited to, at least one of the following: training time exceeds a preset duration; the number of times of training exceeds a preset number of times; and the calculated difference is less than a preset difference threshold.

Here, the model parameter of the joint point prediction sub-model described above and the model parameter of the pose estimation sub-model described above can be adjusted based on the above loss value by using various implementations. For example, a BP (Back Propagation) algorithm or an SGD (Stochastic Gradient Recent) algorithm may be used to adjust the model parameter of the joint point prediction sub-model and the model parameter of the pose estimation sub-model. It should be noted that, any algorithm for adjusting the model parameters may be used to adjust the model parameters, which is not limited herein.

It can be seen from FIG. 4 that, as compared with the embodiment corresponding to FIG. 1, the flow 400 of the method for pose estimation in this embodiment includes steps of determining, when the human pose information is determined by using the joint point prediction sub-model and the pose estimation sub-model, a loss value by using the human pose information and the tag pose information, and adjusting the model parameter of the joint point prediction sub-model and the model parameter of the pose estimation sub-model by using the loss value, and obtaining the adjusted joint point prediction sub-model and the adjusted pose estimation sub-model. Thus, the solution described in this embodiment can adjust the model parameters of the joint point prediction sub-model and the pose estimation sub-model, so that the joint point prediction sub-model and the pose estimation sub-model can perform human pose estimation more accurately.

In some optional implementations, the human pose information may include a relative rotation angle of a human joint point under a human parameterized grid model, and the tag pose information may include a tag relative rotation angle, where the tag relative rotation angle generally refers to a tag relative rotation angle of the human joint point under the human parameterized grid model.

The executing subject may determine the loss value by using the preset loss function based on the human pose information and the tag pose information in the following manner: the executing body may determine, as the loss value, a difference between the relative rotation angle of the human joint point under the human parameterized grid model and the tag relative rotation angle. This supervision manner may be referred to as SMPL rotation angle parameter supervision. In this manner, an output result of the pose estimation sub-model may be as close to the tag value as possible, thereby improving accuracy of the output result of the pose estimation sub-model.

In some optional implementations, the human pose information may include a joint point coordinate of a human joint point under the human parameterized grid model, and the tag pose information may include a tag joint point coordinate, where the tag joint point coordinate generally refers to the tag joint point coordinate of the human joint point under the human parameterized grid model.

The executing subject may determine the loss value by using the preset loss function based on the human pose information and the tag pose information in the following manner: the executing body may determine, as the loss value, a difference between the joint point coordinate of the human joint point under the human parameterized grid model and the tag joint point coordinate. This supervision manner may be referred to as joint point position supervision under SMPL coordinate system. Since a joint point coordinate of a human joint point under the human parameterized grid model is obtained according to the relative rotation angle parameter of the human joint point under the human parameterized grid model, the accuracy of the output result of the pose estimation sub-model may be further improved in this manner.

In some optional implementations, the human pose information may include a joint point coordinate of a hand joint point in a world coordinate system, and the tag pose information may include a tag hand joint point coordinate. The tag hand joint point coordinate usually refer to a joint point coordinate of a hand joint point in the world coordinate system.

The execution body may determine the loss value by using the preset loss function based on the human pose information and the tag pose information in the following manner: the execution body may determine, as the loss value, a difference between the joint point coordinate of the hand joint point in the world coordinate system and the tag hand joint point coordinate. This supervision manner may be referred to as hand alignment supervision. Since a joint point coordinate of a hand joint point in a world coordinate system is obtained from a joint point coordinate of a human joint point under the human parameterized grid model, and the joint point coordinate of the human joint point in the human parameterized grid model are obtained from the relative rotation angle parameter of the human joint point under the human parameterized grid model. In this way, the accuracy of the output result of the pose estimation sub-model can be further improved.

In some optional implementations, the human pose information may include a movement velocity of a human joint point within a preset duration, and the tag pose information may include a tag movement velocity. As an example, the above preset duration may also be understood as a preset collection time period, and the preset collection time period may be a collection time period between N adjacent collection points, for example, the preset collection time period may be a collection time period between two adjacent collection points, may also be a collection time period between three adjacent collection points, and may also be a collection time period between five adjacent collection points.

As an example, if the preset collection time period is a collection time period between two adjacent collection points, the corresponding tag pose information includes a tag movement velocity of the human joint point within the collection time period between the two adjacent collection points; if the preset collection time period is a collection time period between three adjacent collection points, the corresponding tag pose information includes a tag movement velocity of the human joint point within the collection time period between three adjacent collection points; and if the preset collection time period is a collection time period between five adjacent collection points, the corresponding tag pose information includes a tag movement velocity of the human joint point within the collection time period between five adjacent collection points.

The execution subject may determine the loss value by using the preset loss function based on the human pose information and the tag pose information in the following manner: determining, as the loss value, a difference between the movement velocity of the human joint point within the preset duration and the tag movement velocity. Here, the execution subject may determine, as the loss value, a difference between the movement velocity of the human joint point within the collection time period between two adjacent collection points and the corresponding tag movement velocity; the execution subject may also determine, as the loss value, a difference between the movement velocity of the human joint point within the collection time period between three adjacent collection points and the corresponding tag movement velocity; the execution subject may also determine, as the loss value, a difference between the movement velocity of the human joint point within the collection time period between five adjacent collection points and the corresponding tag movement velocity. This supervision manner may be referred to as movement velocity supervision. With this supervision manner, the determined human pose in the movement may be made as smooth and realistic as possible.

In some optional implementations, the human joint point may include a foot joint point, and the execution body may determine, as the loss value, the difference between the movement velocity of the human joint point within the preset duration and the tag movement velocity in the following manner: if a foot is placed on the ground within the preset duration, the execution body may determine, as the loss value, a difference between the movement velocity of the foot joint point within the preset duration and a target velocity. The target velocity is typically zero. This supervision manner may be referred to as foot contact supervision. With this supervision manner, it is possible for the foot that has not left the ground to have as little tendency to move as much as possible.

In some optional implementations, the execution subject may determine the loss value by using the preset loss function based on the human pose information and the tag pose information in the following manner: the above execution subject may determine, by using the human pose information, whether there is a joint point lower than a ground height in the human joint point; if so, determining, as the loss value, a difference between a height of the lowest point in the human joint points lower than the ground and the ground height. This supervision manner may be referred to as ground penetration supervision. With this supervision manner, the human pose can be made as meeting a physical constraint as far as possible, and any joint point of the body is not lower than the ground.

In some optional implementations, the execution body may determine the loss value by using the preset loss function based on the human pose information and the tag pose information in the following manner: if a human foot is placed on a ground, the above execution body may determine, as the loss value, a difference between a height of the lowest point in the human joint points higher than the ground and a ground height. This supervision manner may be referred to as foot height supervision. With this supervision manner, the human pose can be made as meeting a physical constraint as far as possible, so that the grounded foot is not suspended in the air.

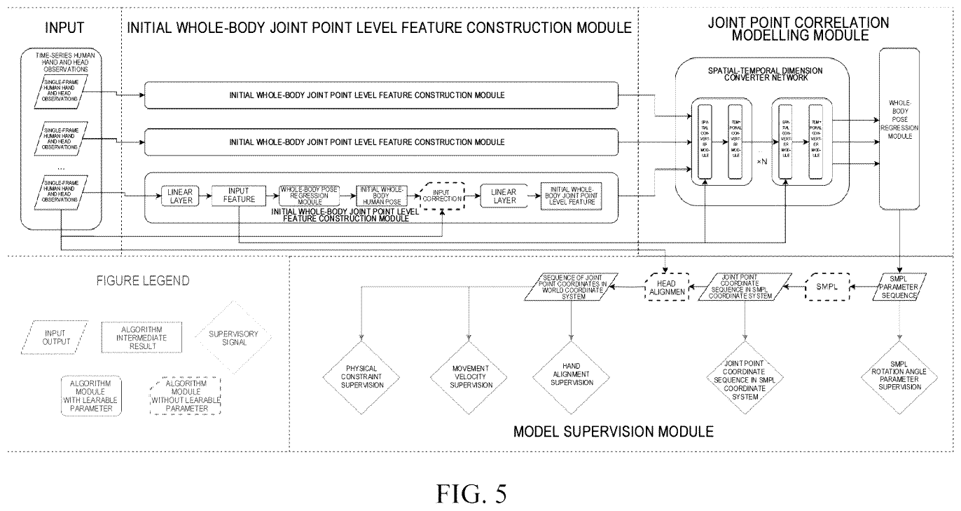

With continued reference to FIG. 5, FIG. 5 is a schematic diagram of an application scenario of the method for pose estimation according to this embodiment. In the application scenario of FIG. 5, the input time-series human hand and head observation information are passed through an initial whole-body joint point level feature construction module, a joint point correlation modeling module, and a model supervision module.

In the initial whole-body joint point level feature construction module, the human hand and head observation information collected each time will pass through the first linear layer, to obtain a high-dimensional input feature, and then the high-dimensional input feature is input into a whole-body pose regression module, to obtain an initial whole-body human pose, and the initial whole-body human pose is compared with the human hand and head observation information, to correct the initial whole-body human pose, and then the corrected initial whole-body human pose is input into the second linear layer, to obtain a high-dimensional initial whole-body joint point level feature.

In a joint point correlation modelling module, the initial whole-body joint point level feature is input into a spatial-temporal dimension converter network, the spatial-temporal dimension converter network includes N sets of sub-networks each consisted of a spatial converter module and a temporal converter module. The temporal converter module is configured for performing interaction on a feature in a spatial dimension, and the temporal converter module is configured for performing interaction on a feature in a temporal dimension. The interaction feature after the spatial-temporal relationship capture is input into the whole-body pose regression module to obtain the relative rotation angle parameter under the SMPL.

In the model supervision module, the output results of the initial whole-body joint point level feature construction module and the joint point correlation modeling module can be supervised using a variety of supervision methods, such as a SMPL rotation angle parameter supervision, a whole-body joint point coordinate supervision in SMPL coordinate system, a hand alignment supervision, movement velocity supervision and physical constraint supervision.

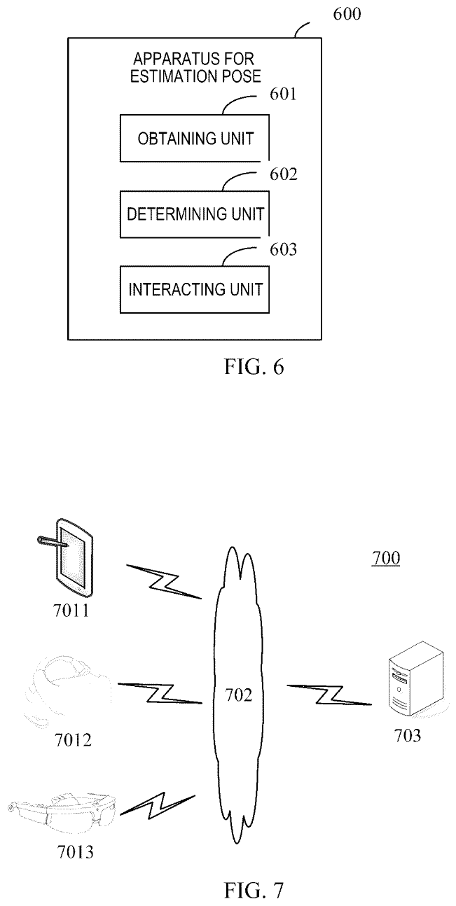

Further referring to FIG. 6, as an implementation of the method shown in the above drawings, the present application provides an embodiment of an apparatus for pose estimation. The apparatus embodiment corresponds to the method embodiment shown in FIG. 1, and the apparatus may be specifically applied to various devices.

As shown in FIG. 6, the pose estimation apparatus 600 of this embodiment includes: an obtaining unit 601, a determining unit 602, and an interacting unit 603. The obtaining unit 601 is configured to obtain an observation information sequence corresponding to a human target part, wherein the human target part comprises at least one of the following: a head and a hand; the determining unit 602 is configured to determine an initial human joint point feature based on the observation information sequence; and the interaction unit 603 is configured to perform feature interaction based on the initial human joint point feature, and estimate a human pose using an interaction feature, so as to obtain human pose information.

In this embodiment, for specific processing of the obtaining unit 601, the determining unit 602, and the interacting unit 603 of the apparatus for pose estimation 600, reference may be made to Step 101, Step 102, and Step 103 in the embodiment corresponding to FIG. 1.

In some optional implementations, the interacting unit 603 may be further configured to perform the feature interaction based on the initial human joint point feature in the following manner: performing the feature interaction in a spatial dimension and/or in a temporal dimension based on the initial human joint point feature.

In some optional implementations, the interaction unit 603 may be further configured to perform the feature interaction in the spatial dimension and/or in the temporal dimension based on the initial human joint point feature in the following manner: for each collection point in a collection time period, determining an attention score between an initial human joint point feature corresponding to the collection point and a target input feature, and performing interaction on the initial human joint point feature corresponding to the collection point and the target input feature by using the attention score, to obtain an interaction feature in the spatial dimension, wherein the target input feature is obtained by mapping a high-dimensional input feature to a same dimension of the initial human joint point feature corresponding to the collection point, the high-dimensional input feature is determined based on the observation information sequence, and the collection time period is a time period for collecting the observation information sequence.

In some optional implementations, the interacting unit 603 may be further configured to perform the feature interaction in the spatial dimension and/or in the temporal dimension based on the initial human joint point feature in the following manner: for each joint point of human joint points, determining an attention score between a plurality of initial joint point features of the joint point within a collection time period; and performing interaction on the plurality of initial joint point features corresponding to the joint point by using the attention score, so as to obtain an interaction feature in the temporal dimension, wherein the collection time period is a time period for collecting the observation information sequence.

In some optional implementations, the interacting unit 603 may be further configured to perform the feature interaction in the spatial dimension and/or in the temporal dimension based on the initial human joint point feature in the following manner: inputting the initial human joint point feature and a target input feature into a pre-trained feature interaction network to obtain an interaction feature, wherein the interaction feature comprises an interaction feature of a human joint point in the spatial dimension and an interaction feature of a human joint point in the temporal dimension, and the target input feature is determined based on the observation information sequence.

In some optional implementations, the feature interaction network includes at least two first coding layers and at least two second coding layers, the first coding layer is configured to perform feature interaction in the spatial dimension, and the second coding layer is configured to perform feature interaction in the temporal dimension; and the interacting unit 603 may further be configured to input the initial human joint point feature and the target input feature into the pre-trained feature interaction network to obtain the interaction feature in the following manner: inputting the initial human joint point feature and the target input feature into alternately arranged first coding layer and second coding layer to obtain the interaction feature.

In some optional implementations, the determining unit 602 may be further configured to determine the initial human joint point feature based on the observation information sequence in the following way: determine initial human pose information based on the observation information sequence; and correct the initial human pose information, and determine the initial human joint point feature based on the corrected human pose information.

In some optional implementations, the initial human pose information includes a relative rotation angle of a human joint point under a human parameterized grid model and/or a joint point coordinate of the human joint point under the human parameterized grid model, and the observation information sequence includes a rotation angle and/or a joint point coordinate of a joint point on the human target part; and the determining unit 602 may be further configured to correct the initial human pose information in the following way: replacing a rotation angle of the joint point on the human target part in the initial human pose information with the rotation angle of the joint point on the human target part in the observation information sequence; replacing a joint point coordinate of the joint point on the human target part in the initial human pose information with the joint point coordinate of the joint point on the human target part in the observation information sequence.

In some optional implementations, the determining unit 602 may be further configured to determine the initial human joint point feature based on the observation information sequence in the following way: inputting the observation information sequence into a pre-trained joint point prediction sub-model to obtain the initial human joint point feature; and the interacting unit 603 may be further configured to perform the feature interaction based on the initial human joint point feature, and estimating the human pose using the interaction feature, so as to obtain the human pose information in the following way: inputting the initial human joint point feature into a pre-trained pose estimation sub-model to obtain the human pose information.

In some optional implementations, the apparatus for estimating a posture 600 may also include: a loss value determining unit (not shown in the drawings) and an adjusting unit (not shown in the drawings). The loss value determining unit may be configured to determine a loss value using a preset loss function based on the human pose information and tag pose information; and the adjusting unit may be configured to adjust, by using the loss value, a model parameter of the joint point prediction sub-model and a model parameter of the pose estimation sub-model, to obtain the adjusted joint point prediction sub-model and the adjusted pose estimation sub-model.

In some optional implementations, the human pose information includes a relative rotation angle of a human joint point under a human parameterized grid model, and the tag pose information includes a tag relative rotation angle; and the loss value determining unit is further configured to determine the loss value using the preset loss function based on the human pose information and the tag pose information in the following way: determining, as the loss value, a difference between the relative rotation angle of the human joint point under the human parameterized grid model and the tag relative rotation angle.

In some optional implementations, the human pose information includes a joint point coordinate of a human joint point under a human parameterized grid model, and the tag pose information includes a tag joint point coordinate; and the loss value determining unit is further configured to determine the loss value using the preset loss function based on the human pose information and the tag pose information in the following way: determining, as the loss value, a difference between the joint point coordinate of the human joint point under the human parameterized grid model and the tag joint point coordinate.

In some optional implementations, the human pose information includes a joint point coordinate of a hand joint point in a world coordinate system, and the tag pose information includes a tag hand joint point coordinate; and the loss value determining unit is further configured to determine the loss value using the preset loss function based on the human pose information and the tag pose information in the following way: determining, as the loss value, a difference between the joint point coordinate of the hand joint point in the world coordinate system and the tag hand joint point coordinate.

In some optional implementations, the human pose information includes a movement velocity of a human joint point within a preset duration, and the tag pose information includes a tag movement velocity; and the loss value determining unit may be further configured to determine the loss value by using the preset loss function based on the human pose information and the tag pose information in the following manner: determining, as the loss value, a difference between the movement velocity of the human joint point within the preset duration and the tag movement velocity.

In some optional implementations, the human joint point includes a foot joint point; and the loss value determining unit may be further configured to determine, as the loss value, the difference between the movement velocity of the human joint point within the preset duration and the tag movement velocity in the following manner: if a foot is placed on the ground within the preset duration, determining, as the loss value, a difference between the movement velocity of the foot joint point within the preset duration and a target velocity.

In some optional implementations, the loss value determining unit may be further configured to determine the loss value by using the preset loss function based on the human pose information and the tag pose information in the following manner: determining, by using the human pose information, whether there is a joint point lower than a ground height in human joint points; and in response to that there is a joint point lower than the ground height, determining, as the loss value, a difference between a height of the lowest point in the human joint points lower than the ground and the ground height.

In some optional implementations, the loss value determining unit may be further configured to determine the loss value by using the preset loss function based on the human pose information and the tag pose information in the following manner: in response to that a human foot is placed on a ground, determining, as the loss value, a difference between a height of the lowest point in the human joint points higher than the ground and the ground height.

In some alternative implementations, the observation information includes a movement velocity and an angular velocity of a joint point.

FIG. 7 illustrates an exemplary system architecture 700 in which embodiments of a method for pose estimation of the present disclosure may be applied.

As shown in FIG. 7, the system architecture 700 may include terminal devices 7011, 7012, 7013, a network 702 and a server 703. The network 702 is configured to provide the communication link medium between the terminal devices 7011, 7012, 7013 and the server 703. The network 702 may include various connection types, such as wire, wireless communication links, or optic fiber cables, among others.

A user may use the terminal devices 7011, 7012, and 7013 to interact with the server 703 over the network 702 to send or receive messages and the like. For example, the server 703 may receive the observation information sequence sent by the terminal devices 7011, 7012, and 7013. Various communication client applications may be installed on the terminal devices 7011, 7012, and 7013, for example, an image processing application, an image capturing application, a game application, and instant messaging software.

The terminal devices 7011, 7012, and 7013 may be hardware or software. When the terminal devices 7011, 7012, and 7013 are hardware, the terminal devices may be various electronic devices that have a camera, a display screen, and support information interaction, including but not limited to a VR headset, AR glasses, a smart camera, a smartphone, a tablet computer, a laptop computer, and the like. When the terminal devices 7011, 7012, and 7013 are software, the terminal devices 7011, 7012, and 7013 may be installed in the above listed electronic devices, and may be implemented as a plurality of pieces of software or software modules (for example, a plurality of pieces of software or software modules used to provide a distributed service), or may be implemented as a single piece of software or software module. No limitation will be given here.

The terminal devices 7011, 7012, and 7013 may obtain an observation information sequence corresponding to the head and/or the hand, and then determine initial human joint point feature based on the observation information sequence; then, feature interaction is performed based on the initial human joint point feature, and a human pose is estimated by using an interaction feature, so as to obtain human pose information.

The server 703 may be a server that provides various services, and may be, for example, a backend server that processes an observation information sequence corresponding to a head and/or a hand. The server 703 may first obtain the observation information sequence corresponding to the head and/or hand from the terminal devices 7011, 7012, and 7013; then, an initial human joint point feature can be determined based on the above observation information sequence; and then feature interaction is performed based on the initial human joint point feature, and a human pose is estimated by using the interaction feature, so as to obtain human pose information.

It should be noted that, the server 703 may be hardware or software. When the server 703 is hardware, the server 703 may be implemented as a distributed server cluster formed by a plurality of servers, or may be implemented as a single server. When the server 703 is software, the server 703 may be implemented as a plurality of software or software modules (for example, to provide a distributed service), or may be implemented as a single software or software module. No limitation will be given here.

It should be further noted that the method for pose estimation provided in the embodiment of the present disclosure may be executed by the terminal devices 7011, 7012, and 7013. In this case, the apparatus for pose estimation is generally disposed in the terminal devices 7011, 7012, and 7013; the method for pose estimation provided in the embodiment of the present disclosure may also be executed by the server 703. In this case, the apparatus for pose estimation is generally disposed in the server 703.

It should be understood that the number of terminal devices, networks, and servers in FIG. 7 are merely illustrative and any number of terminal devices, networks, and servers may be present depending on the implementation requirements.

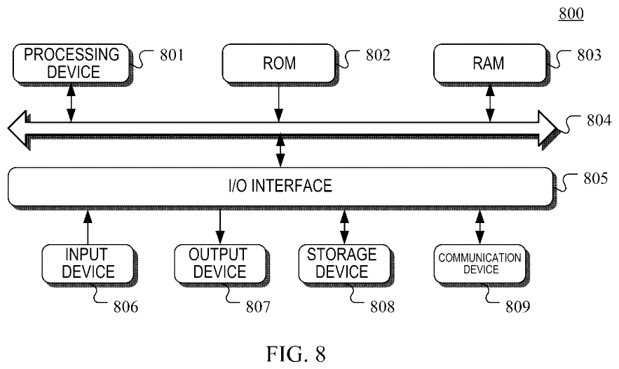

Referring now to FIG. 8, FIG. 8 illustrates a block diagram of an electronic device (e.g., a server in FIG. 7) 800 suitable for implementing embodiments of the present disclosure. The electronic device shown in FIG. 8 is only one example and should not bring any limitation to the functions and scope of use of embodiments of the present disclosure.

As shown in FIG. 8, the electronic device 800 may include a processing device (such as a central processing unit, graphics processing unit, etc.) 801, which may perform various appropriate actions and processes based on programs stored in Read-Only Memory (ROM) 802 or loaded from storage device 808 into Random Access Memory (RAM) 803. In the RAM 803, various programs and data necessary for the operation of the electronic device 800 are also stored. The processing device 801, ROM 802, and RAM 803 are connected to each other through a bus 804. An Input/Output I/O interface 805 is also connected to the bus 804.

Typically, the following devices can be connected to I/O interface 805: input devices 806 including, for example, touch screens, touchpads, keyboards, mice, cameras, microphones, accelerometers, gyroscopes, etc.; output devices 807 including liquid crystal displays (LCDs), speakers, vibrators, etc.; storage devices 808 including magnetic tapes, hard disks, etc.; and a communication device 809. The communication device 809 may allow the electronic device 800 to communicate with other devices wirelessly or wirelessly to exchange data. Although FIG. 8 shows an electronic device 800 with a plurality of devices, it shall be understood that it is not required to implement or have all of the devices shown. More or fewer devices can be implemented or provided instead. More or fewer devices may alternatively be implemented or provided. Each block shown in FIG. 8 may represent a single device or multiple devices as desired.

In particular, according to embodiments of the present disclosure, the process described above with reference to the flowchart can be implemented as a computer software program. For example, an embodiment of the present disclosure includes a computer program product that includes a computer program carried on a computer-readable medium, where the computer program includes program code for performing the method shown in the flowchart. In such an embodiment, the computer program can be downloaded and installed from a network through the communication device 809, or installed from the storage device 808, or installed from the ROM 802. When the computer program is executed by the processing device 801, the above functions defined in the method of the embodiment of the present disclosure are performed. It should be noted that the computer-readable medium described in the embodiments of the present disclosure can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, a portable computer disk, a hard disk, random access memory (RAM), read-only memory (ROM), an erasable programmable read-only memory (EPROM or flash memory), an optical fiber, a portable compact disk read-only memory (CD-ROM), an optical storage device, a magnetic storage device, or any suitable combination thereof. In the embodiments of the present disclosure, a computer-readable storage medium may be any tangible medium containing or storing a program that can be used by an instruction execution system, apparatus, or device, or can be used in combination with an instruction execution system, apparatus, or device. In the embodiments of the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, including but not limited to: wires, optical cables, RF (radio frequency), etc., or any suitable combination thereof.

The computer readable medium may be included in the electronic device, or it can exist alone without being assembled into the electronic device. The computer readable medium carries one or more programs, and when the above-mentioned one or more programs are executed by the electronic device, the electronic device: obtain hand images captured at least two angles of view; based on a preset hand three-dimensional reconstruction network, determining an initial hand three-dimensional reconstruction result corresponding to each hand image, wherein the hand three-dimensional reconstruction result includes a hand three-dimensional model and hand key points; fusing the initial hand three-dimensional reconstruction results corresponding to the hand images acquired from the at least two angles of view to obtain a fused hand three-dimensional reconstruction result.

Computer program codes for performing the operations of the present disclosure may be written in one or more programming languages or a combination thereof, including but not limited to Object Oriented programming languages-such as Java, Smalltalk, C++, and also conventional procedural programming languages-such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network-including local area network (LAN) or wide area network (WAN)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

According to one or more embodiments of the present disclosure, there is provided a hand three-dimensional reconstruction method,

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

According to one or more embodiments of the present disclosure, there is provided a method for pose estimation. The method includes: obtaining an observation information sequence corresponding to a human target part, wherein the human target part includes at least one of the following: a head and a hand; determining an initial human joint point feature based on the observation information sequence; and performing feature interaction based on the initial human joint point feature, and estimating a human pose using an interaction feature, so as to obtain human pose information.

According to one or more embodiments of the present disclosure, performing the feature interaction based on the initial human joint point feature includes: performing the feature interaction in a spatial dimension and/or in a temporal dimension based on the initial human joint point feature.

According to one or more embodiments of the present disclosure, performing the feature interaction in the spatial dimension and/or in the temporal dimension based on the initial human joint point feature includes: for each collection point in a collection time period, determining an attention score between an initial human joint point feature corresponding to the collection point and a target input feature, and performing interaction on the initial human joint point feature corresponding to the collection point and the target input feature by using the attention score, to obtain an interaction feature in the spatial dimension, wherein the target input feature is obtained by mapping a high-dimensional input feature to a same dimension of the initial human joint point feature corresponding to the collection point, the high-dimensional input feature is determined based on the observation information sequence, and the collection time period is a time period for collecting the observation information sequence.

According to one or more embodiments of the present disclosure, performing the feature interaction in the spatial dimension and/or in the temporal dimension based on the initial human joint point feature includes: for each joint point of human joint points, determining an attention score between a plurality of initial joint point features of the joint point within a collection time period; and performing interaction on the plurality of initial joint point features corresponding to the joint point by using the attention score, so as to obtain an interaction feature in the temporal dimension, wherein the collection time period is a time period for collecting the observation information sequence.

According to one or more embodiments of the present disclosure, performing the feature interaction in the spatial dimension and/or in the temporal dimension based on the initial human joint point feature includes: inputting the initial human joint point feature and a target input feature into a pre-trained feature interaction network to obtain an interaction feature, wherein the interaction feature comprises an interaction feature of a human joint point in the spatial dimension and an interaction feature of a human joint point in the temporal dimension, and the target input feature is determined based on the observation information sequence.

According to one or more embodiments of the present disclosure, the feature interaction network includes at least two first coding layers and at least two second coding layers, the first coding layer is configured to perform feature interaction in the spatial dimension, and the second coding layer is configured to perform feature interaction in the temporal dimension; and inputting the initial human joint point feature and the target input feature into the pre-trained feature interaction network to obtain the interaction feature includes: inputting the initial human joint point feature and the target input feature into alternately arranged first coding layer and second coding layer to obtain the interaction feature.

According to one or more embodiments of the present disclosure, determining the initial human joint point feature based on the observation information sequence includes: determining initial human pose information based on the observation information sequence; and correcting the initial human pose information, and determining the initial human joint point feature based on the corrected human pose information.

According to one or more embodiments of the present disclosure, the initial human pose information includes a relative rotation angle of a human joint point under a human parameterized grid model and/or a joint point coordinate of the human joint point under the human parameterized grid model, and the observation information sequence comprises a rotation angle and/or a joint point coordinate of a joint point on the human target part; and correcting the initial human pose information comprises at least one of: replacing a rotation angle of the joint point on the human target part in the initial human pose information with the rotation angle of the joint point on the human target part in the observation information sequence; replacing a joint point coordinate of the joint point on the human target part in the initial human pose information with the joint point coordinate of the joint point on the human target part in the observation information sequence.

According to one or more embodiments of the present disclosure, determining the initial human joint point feature based on the observation information sequence includes: inputting the observation information sequence into a pre-trained joint point prediction sub-model to obtain the initial human joint point feature; and performing the feature interaction based on the initial human joint point feature, and estimating the human pose using the interaction feature, so as to obtain the human pose information includes: inputting the initial human joint point feature into a pre-trained pose estimation sub-model to obtain the human pose information.

According to one or more embodiments of the present disclosure, the method further comprises: determining a loss value using a preset loss function based on the human pose information and tag pose information; and adjusting, by using the loss value, a model parameter of the joint point prediction sub-model and a model parameter of the pose estimation sub-model, to obtain the adjusted joint point prediction sub-model and the adjusted pose estimation sub-model.

According to one or more embodiments of the present disclosure, the human pose information includes a relative rotation angle of a human joint point under a human parameterized grid model, and the tag pose information includes a tag relative rotation angle; and determining the loss value using the preset loss function based on the human pose information and the tag pose information includes: determining, as the loss value, a difference between the relative rotation angle of the human joint point under the human parameterized grid model and the tag relative rotation angle.

According to one or more embodiments of the present disclosure, the human pose information includes a joint point coordinate of a human joint point under a human parameterized grid model, and the tag pose information comprises a tag joint point coordinate; and determining the loss value using the preset loss function based on the human pose information and the tag pose information includes: determining, as the loss value, a difference between the joint point coordinate of the human joint point under the human parameterized grid model and the tag joint point coordinate.

According to one or more embodiments of the present disclosure, the human pose information includes a joint point coordinate of a hand joint point in a world coordinate system, and the tag pose information includes a tag hand joint point coordinate; and determining the loss value using the preset loss function based on the human pose information and the tag pose information includes: determining, as the loss value, a difference between the joint point coordinate of the hand joint point in the world coordinate system and the tag hand joint point coordinate.

According to one or more embodiments of the present disclosure, the human pose information includes a movement velocity of a human joint point within a preset duration, and the tag pose information includes a tag movement velocity; and determining the loss value using the preset loss function based on the human pose information and the tag pose information includes: determining, as the loss value, a difference between the movement velocity of the human joint point within the preset duration and the tag movement velocity.

According to one or more embodiments of the present disclosure, the human joint point includes a foot joint point; and determining, as the loss value, the difference between the movement velocity of the human joint point within the preset duration and the tag movement velocity includes: if a foot is placed on the ground within the preset duration, determining, as the loss value, a difference between the movement velocity of the foot joint point within the preset duration and a target velocity.

According to one or more embodiments of the present disclosure, determining the loss value using the preset loss function based on the human pose information and the tag pose information includes: determining, by using the human pose information, whether there is a joint point lower than a ground height in human joint points; and in response to that there is a joint point lower than the ground height, determining, as the loss value, a difference between a height of the lowest point in the human joint points lower than the ground and the ground height.

According to one or more embodiments of the present disclosure, determining the loss value using the preset loss function based on the human pose information and the tag pose information includes: in response to that a human foot is placed on a ground, determining, as the loss value, a difference between a height of the lowest point in the human joint points higher than the ground and the ground height.

According to one or more embodiments of the present disclosure, the observation information includes a movement velocity and an angular velocity of a joint point.

According to one or more embodiments of the present disclosure, there is provided an apparatus for pose estimation. The apparatus includes: an obtaining unit configured to obtain an observation information sequence corresponding to a human target part, wherein the human target part comprises at least one of the following: a head and a hand; a determining unit configured to determine an initial human joint point feature based on the observation information sequence; and an interacting unit configured to perform feature interaction based on the initial human joint point feature, and estimate a human pose using an interaction feature, so as to obtain human pose information.

According to one or more embodiments of the present disclosure, the interacting unit is further configured to perform the feature interaction based on the initial human joint point feature in the following manner: performing the feature interaction in a spatial dimension and/or in a temporal dimension based on the initial human joint point feature.

According to one or more embodiments of the present disclosure, the interacting unit is further configured to perform the feature interaction in the spatial dimension and/or in the temporal dimension based on the initial human joint point feature in the following manner: for each collection point in a collection time period, determining an attention score between an initial human joint point feature corresponding to the collection point and a target input feature, and performing interaction on the initial human joint point feature corresponding to the collection point and the target input feature by using the attention score, to obtain an interaction feature in the spatial dimension, wherein the target input feature is obtained by mapping a high-dimensional input feature to a same dimension of the initial human joint point feature corresponding to the collection point, the high-dimensional input feature is determined based on the observation information sequence, and the collection time period is a time period for collecting the observation information sequence.

According to one or more embodiments of the present disclosure, the interacting unit is further configured to perform the feature interaction in the spatial dimension and/or in the temporal dimension based on the initial human joint point feature in the following manner: for each joint point of human joint points, determining an attention score between a plurality of initial joint point features of the joint point within a collection time period; and performing interaction on the plurality of initial joint point features corresponding to the joint point by using the attention score, so as to obtain an interaction feature in the temporal dimension, wherein the collection time period is a time period for collecting the observation information sequence.

According to one or more embodiments of the present disclosure, the interacting unit is further configured to performing the feature interaction in the spatial dimension and/or in the temporal dimension based on the initial human joint point feature: inputting the initial human joint point feature and a target input feature into a pre-trained feature interaction network to obtain an interaction feature, wherein the interaction feature comprises an interaction feature of a human joint point in the spatial dimension and an interaction feature of a human joint point in the temporal dimension, and the target input feature is determined based on the observation information sequence.

According to one or more embodiments of the present disclosure, the feature interaction network comprises at least two first coding layers and at least two second coding layers, the first coding layer is configured to perform feature interaction in the spatial dimension, and the second coding layer is configured to perform feature interaction in the temporal dimension; and the interacting unit is further configured to input the initial human joint point feature and the target input feature into the pre-trained feature interaction network to obtain the interaction feature in the following manner: inputting the initial human joint point feature and the target input feature into alternately arranged first coding layer and second coding layer to obtain the interaction feature.

According to one or more embodiments of the present disclosure, the determining unit is further configured to determine the initial human joint point feature based on the observation information sequence in the following manner: determining initial human pose information based on the observation information sequence; and correcting the initial human pose information, and determining the initial human joint point feature based on the corrected human pose information.

According to one or more embodiments of the present disclosure, the initial human pose information includes a relative rotation angle of a human joint point under a human parameterized grid model and/or a joint point coordinate of the human joint point under the human parameterized grid model, and the observation information sequence includes a rotation angle and/or a joint point coordinate of a joint point on the human target part; and the determining unit is further configured to correct correcting the initial human pose information in at least one of the following manner: replacing a rotation angle of the joint point on the human target part in the initial human pose information with the rotation angle of the joint point on the human target part in the observation information sequence; replacing a joint point coordinate of the joint point on the human target part in the initial human pose information with the joint point coordinate of the joint point on the human target part in the observation information sequence.

According to one or more embodiments of the present disclosure, the determining unit is further configured to determine the initial human joint point feature based on the observation information sequence in the following manner: inputting the observation information sequence into a pre-trained joint point prediction sub-model to obtain the initial human joint point feature; and the interaction unit is further used to perform feature interaction based on the initial human joint point feature, and estimating the human pose using the interaction feature, so as to obtain the human pose information in the following manner: inputting the initial human joint point feature into a pre-trained pose estimation sub-model to obtain the human pose information.

According to one or more embodiments of the present disclosure, the apparatus for pose estimation includes a loss value determining unit and an adjusting unit. The loss value determining unit is configured to determine a loss value using a preset loss function based on the human pose information and tag pose information; the adjusting unit is configured to adjust, by using the loss value, a model parameter of the joint point prediction sub-model and a model parameter of the pose estimation sub-model, to obtain the adjusted joint point prediction sub-model and the adjusted pose estimation sub-model.

According to one or more embodiments of the present disclosure, the human pose information includes a relative rotation angle of a human joint point under a human parameterized grid model, and the tag pose information includes a tag relative rotation angle; and the loss value determining unit is further configured to determine, as the loss value, a difference between the relative rotation angle of the human joint point under the human parameterized grid model and the tag relative rotation angle.

According to one or more embodiments of the present disclosure, the human pose information includes a joint point coordinate of a human joint point under a human parameterized grid model, and the tag pose information includes a tag joint point coordinate; and the loss value determining unit is further configured to determine the loss value using the preset loss function based on the human pose information and the tag pose information in the following manner: determining, as the loss value, a difference between the joint point coordinate of the human joint point under the human parameterized grid model and the tag joint point coordinate.

According to one or more embodiments of the present disclosure, the human pose information includes a joint point coordinate of a hand joint point in a world coordinate system, and the tag pose information includes a tag hand joint point coordinate; and the loss value determining unit is further configured to determine the loss value using the preset loss function based on the human pose information and the tag pose information in the following manner: determining, as the loss value, a difference between the joint point coordinate of the hand joint point in the world coordinate system and the tag hand joint point coordinate.

According to one or more embodiments of the present disclosure, the human pose information includes a movement velocity of a human joint point within a preset duration, and the tag pose information includes a tag movement velocity; and the loss value determining unit is further configured to determine the loss value using the preset loss function based on the human pose information and the tag pose information in the following manner: determining, as the loss value, a difference between the movement velocity of the human joint point within the preset duration and the tag movement velocity.

According to one or more embodiments of the present disclosure, the human joint point includes a foot joint point; and the loss value determining unit is further configured to determine, as the loss value, the difference between the movement velocity of the human joint point within the preset duration and the tag movement velocity in the following manner: if a foot is placed on the ground within the preset duration, determining, as the loss value, a difference between the movement velocity of the foot joint point within the preset duration and a target velocity.

According to one or more embodiments of the present disclosure, the loss value determining unit is further configured to determine the loss value using the preset loss function based on the human pose information and the tag pose information in the following manner: determining, by using the human pose information, whether there is a joint point lower than a ground height in human joint points; in response to that there is a joint point lower than the ground height, determining, as the loss value, a difference between a height of the lowest point in the human joint points lower than the ground and the ground height.

According to one or more embodiments of the present disclosure, the loss value determining unit is further configured to determine the loss value using the preset loss function based on the human pose information and the tag pose information in the following manner: in response to that a human foot is placed on a ground, determining, as the loss value, a difference between a height of the lowest point in the human joint points higher than the ground and the ground height.

According to one or more embodiments of the present disclosure, the observation information includes a movement velocity and an angular velocity of a joint point.

The units involved in the embodiments of the present disclosure may be implemented through software, or may also be implemented through hardware. The units described may also be disposed in a processor. For example, a processor may be described as including an obtaining unit, a determining unit, and an interacting unit. The names of these units do not constitute a limitation to the units themselves in a certain case. For example, the obtaining unit may also be described as “a unit for obtaining an observation information sequence corresponding to a human target part”.

The above description is merely illustrative of the preferred embodiments of the present disclosure and of the technical principles applied thereto, as will be appreciated by those skilled in the art, the scope of the present disclosure involved in the embodiments of the present disclosure is not limited to the technical solution formed by the specific combination of the described technical features. At the same time, it should also cover other technical solutions formed by any combination of the described technical features or equivalent features thereof without departing from the described inventive concept. For example, the foregoing features and technical features having similar functions disclosed in the embodiments of the present disclosure (but not limited to) are interchangeable in forming technical solutions.

1. A method for pose estimation, comprising:
obtaining an observation information sequence corresponding to a human target part, wherein the human target part comprises at least one of a head or a hand;
determining an initial human joint point feature based on the observation information sequence; and
performing feature interaction based on the initial human joint point feature, and estimating a human pose with an interaction feature to obtain human pose information.

2. The method of claim 1, wherein the performing feature interaction based on the initial human joint point feature comprises:
performing the feature interaction in a spatial dimension and/or in a temporal dimension based on the initial human joint point feature.

3. The method of claim 2, wherein the performing the feature interaction in the spatial dimension and/or in the temporal dimension based on the initial human joint point feature comprises:
for each collection point in a collection time period, determining an attention score between an initial human joint point feature corresponding to the collection point and a target input feature, and performing interaction on the initial human joint point feature corresponding to the collection point and the target input feature with the attention score, to obtain an interaction feature in the spatial dimension, wherein the target input feature is obtained by mapping a high-dimensional input feature to a same dimension of the initial human joint point feature corresponding to the collection point, the high-dimensional input feature being determined based on the observation information sequence, and the collection time period is a time period for collecting the observation information sequence.

4. The method of claim 2, wherein the performing the feature interaction in the spatial dimension and/or in the temporal dimension based on the initial human joint point feature comprises:
for each joint point of human joint points, determining an attention score between a plurality of initial joint point features of the joint point within a collection time period; and performing interaction on the plurality of initial joint point features corresponding to the joint point with the attention score, to obtain an interaction feature in the temporal dimension, wherein the collection time period is a time period for collecting the observation information sequence.

5. The method of claim 2, wherein the performing the feature interaction in the spatial dimension and/or in the temporal dimension based on the initial human joint point feature comprises:
inputting the initial human joint point feature and a target input feature into a pre-trained feature interaction network to obtain an interaction feature, wherein the interaction feature comprises an interaction feature of a human joint point in the spatial dimension and an interaction feature of a human joint point in the temporal dimension, and the target input feature is determined based on the observation information sequence.

6. The method of claim 5, wherein the feature interaction network comprises at least two first coding layers and at least two second coding layers, the first coding layer is configured to perform feature interaction in the spatial dimension, and the second coding layer is configured to perform feature interaction in the temporal dimension; and
the inputting the initial human joint point feature and the target input feature into the pre-trained feature interaction network to obtain the interaction feature comprises:
inputting the initial human joint point feature and the target input feature into alternately arranged first coding layer and second coding layer to obtain the interaction feature.

7. The method of claim 1, wherein the determining the initial human joint point feature based on the observation information sequence comprises:
determining initial human pose information based on the observation information sequence; and
correcting the initial human pose information, and determining the initial human joint point feature based on the corrected human pose information.

8. The method of claim 7, wherein the initial human pose information comprises a relative rotation angle of a human joint point under a human parameterized grid model and/or a joint point coordinate of the human joint point under the human parameterized grid model, and the observation information sequence comprises a rotation angle and/or a joint point coordinate of a joint point on the human target part; and
correcting the initial human pose information comprises at least one of:
replacing a rotation angle of the joint point on the human target part in the initial human pose information with the rotation angle of the joint point on the human target part in the observation information sequence;
replacing a joint point coordinate of the joint point on the human target part in the initial human pose information with the joint point coordinate of the joint point on the human target part in the observation information sequence.

9. The method of claim 1, wherein determining the initial human joint point feature based on the observation information sequence comprises:
inputting the observation information sequence into a pre-trained joint point prediction sub-model to obtain the initial human joint point feature; and
performing the feature interaction based on the initial human joint point feature, and estimating the human pose with the interaction feature to obtain the human pose information comprises:
inputting the initial human joint point feature into a pre-trained pose estimation sub-model to obtain the human pose information.

10. The method of claim 9, further comprising:
determining a loss value with a preset loss function based on the human pose information and tag pose information; and
adjusting, with the loss value, a model parameter of the joint point prediction sub-model and a model parameter of the pose estimation sub-model, to obtain the adjusted joint point prediction sub-model and the adjusted pose estimation sub-model.

11. The method of claim 10, wherein the human pose information comprises a relative rotation angle of a human joint point under a human parameterized grid model, and the tag pose information comprises a tag relative rotation angle; and
determining the loss value with the preset loss function based on the human pose information and the tag pose information comprises:
determining, as the loss value, a difference between the relative rotation angle of the human joint point under the human parameterized grid model and the tag relative rotation angle.

12. The method of claim 10, wherein the human pose information comprises a joint point coordinate of a human joint point under a human parameterized grid model, and the tag pose information comprises a tag joint point coordinate; and
determining the loss value with the preset loss function based on the human pose information and the tag pose information comprises:
determining, as the loss value, a difference between the joint point coordinate of the human joint point under the human parameterized grid model and the tag joint point coordinate.

13. The method of claim 10, wherein the human pose information comprises a joint point coordinate of a hand joint point in a world coordinate system, and the tag pose information comprises a tag hand joint point coordinate; and
determining the loss value with the preset loss function based on the human pose information and the tag pose information comprises:
determining, as the loss value, a difference between the joint point coordinate of the hand joint point in the world coordinate system and the tag hand joint point coordinate.

14. The method of claim 10, wherein the human pose information comprises a movement velocity of a human joint point within a preset duration, and the tag pose information comprises a tag movement velocity; and
determining the loss value with the preset loss function based on the human pose information and the tag pose information comprises:
determining, as the loss value, a difference between the movement velocity of the human joint point within the preset duration and the tag movement velocity.

15. The method of claim 14, wherein the human joint point comprises a foot joint point; and
determining, as the loss value, the difference between the movement velocity of the human joint point within the preset duration and the tag movement velocity comprises:
if a foot is placed on the ground within the preset duration, determining, as the loss value, a difference between the movement velocity of the foot joint point within the preset duration and a target velocity.

16. The method of claim 10, wherein determining the loss value with the preset loss function based on the human pose information and the tag pose information comprises:
determining, with the human pose information, whether there is a joint point lower than a ground height in human joint points; and
in response to that there is a joint point lower than the ground height, determining, as the loss value, a difference between a height of the lowest point in the human joint points lower than the ground and the ground height.

17. The method of claim 10, wherein determining the loss value with the preset loss function based on the human pose information and the tag pose information comprises:
in response to that a human foot is placed on a ground, determining, as the loss value, a difference between a height of the lowest point in the human joint points higher than the ground and the ground height.

18. The method of claim 1, wherein the observation information comprises a movement velocity and an angular velocity of a joint point.

19. An electronic device, comprising:
one or more processors;
a storage device having one or more programs stored thereon,
when being executed by the one or more processors, the one or more processors implement a method for pose estimation comprising:
obtaining an observation information sequence corresponding to a human target part, wherein the human target part comprises at least one of a head or a hand;
determining an initial human joint point feature based on the observation information sequence; and
performing feature interaction based on the initial human joint point feature, and estimating a human pose with an interaction feature to obtain human pose information.

20. A non-transitory computer readable medium, on which a computer program is stored, wherein when being executed by a processor, the program implements a method for pose estimation comprising:
obtaining an observation information sequence corresponding to a human target part, wherein the human target part comprises at least one of a head or a hand;
determining an initial human joint point feature based on the observation information sequence; and
performing feature interaction based on the initial human joint point feature, and estimating a human pose with an interaction feature to obtain human pose information.
